(19) United States
(12) Patent Application Publication
(10) Pub. No.: US 2026/0291049 A1
(43) Pub. Date: Sep. 24, 2026

(54) RFID TAG READERS WITH ANGLED ANTENNA GROUPS

(71) Applicant: Automaton, Inc., San Diego, CA (US)

(72) Inventors: Joe Mueller, San Diego, CA (US); Phillip A. Lindsey, Atlanta, KS (US); Jeff Goos, San Diego, CA (US); Craig Owens, San Carlos, CA (US)

(73) Assignee: Automaton, Inc., San Diego, CA (US)

(21) Appl. No.: 19/682,970

(22) Filed: May 20, 2026

Related U.S. Application Data
(63) Continuation of application No. PCT/US2024/056841, filed on Nov. 21, 2024.
(60) Provisional application No. 63/602,110, filed on Nov. 22, 2023.

(51) Int. Cl. H01Q 1/22; G01S 13/75; H01Q 3/24; H01Q 9/04; H01Q 21/20

(52) U.S. Cl. CPC H01Q 1/2216; G01S 13/75; H01Q 3/247; H01Q 9/0407; H01Q 21/20

(57) ABSTRACT

A sensor for the detection of radio-frequency identification (RFID) tags is disclosed. The sensor includes an antenna array including a plurality of antenna elements disposed on relative facets of a surface. Each antenna element is disposed such that a boresight of each antenna element is not parallel with a boresight of another antenna element of the antenna array. A processor is configured to control the transmission of one or more interrogation signals from a plurality of antenna elements of the antenna array.

### CROSS-REFERENCES TO RELATED APPLICATION(S)

This application is a bypass continuation of International Application No. PCT/US 2024/056841, filed Nov. 21, 2024, and entitled “RFID Tag Readers with Angled Antenna Groups,” which claims the priority benefit, under 35 U.S.C. 119(e), of U.S. Application No. 63/602,110, filed Nov. 22, 2023, and entitled “Determining RFID Tag Location Using Angled Antenna Groups,” each of which is incorporated herein by reference in its entirety for all purposes.

### BACKGROUND

A radio-frequency identification (RFID) tag reader, also called an RFID tag interrogator, a reader, or a sensor, is a device that communicates with RFID tags. A passive RFID tag is powered by the signal transmitted by the reader. The maximum distance or range between the antenna(s) of a reader and a passive RFID tag depends on the maximum power of the RF signal transmitted by the reader toward the RFID tag, the minimum turn-on power or sensitivity of the RFID tag, the maximum power of the tag's reply, the loss in the communications channel between the reader and the RFID tag, noise, interference, and the sensitivity of the reader. The maximum power of the RF signal from the reader is usually limited by a government regulatory body to prevent interference with other wireless devices. In the United States, the Federal Communications Commission (FCC) limits the maximum power of RF signals transmitted by RFID tag readers to an effective isotropic radiated power (EIRP) of 36 dBm (4 W). A passive RFID tag typically reflects or back-scatters about 10% of the incident power in the RF signal from the reader as its reply. This efficiency translates to a loss of about 10 dB. If round-trip channel loss is 80 dB due to scattering, reflections, and/or attenuation, then the signal power of the tag's reply reaching the reader is about −54 dBm (4 nW). Neglecting noise and interference, if the reader's sensitivity is −70 dBm and the desired signal-to-noise ratio (SNR) is 10 dB, then the reader should be able to detect and decode the RFID tag's reply.

The round-trip channel loss generally increases with range, so increasing the reader's range generally involves some combination of increasing the transmitted signal power, increasing the tag back-scattering efficiency and sensitivity, reducing noise and interference, and improving the reader sensitivity. Unfortunately, the FCC limits the maximum signal power transmitted to the tag (and hence the amount of power available for the tag's reply) and thermal noise fundamentally limits the reader sensitivity. With some conventional systems, FCC regulations on maximum transmitted power and path loss limit the maximum achievable range from a conventional reader to a passive RFID tag to about 15 meters.

Cross-talk between adjacent antenna elements in the same reader also limits sensitivity and range. Cross-talk occurs when a portion of the transmission from a first antenna element of the reader is detected by a second antenna element of the reader, e.g., through a path within the reader, by line-of-sight transmission, or from local reflections. This unwanted signal can obscure a tag's response and generate additional noise at the receiver.

### SUMMARY

A radio-frequency identification (RFID) tag reader may use one or more antennas, or antenna elements, to transmit interrogation signals to RFID tags and determine the location of one or more of those tags. In a reader with a conventional phased array, also called an antenna array, the antennas or antenna elements that make up the conventional antenna array are disposed on a planar surface, such as single face of a structure, such that the rays extending normal to the antenna elements are parallel to each other.

The direction normal to the antenna elements is typically the axis of maximum gain and is called the antenna boresight, or boresight for short. In a conventional antenna array, antenna elements with parallel boresights can experience undesirable cross-talk with neighboring antenna elements in the antenna array—power radiated by each antenna element is detected by neighboring antenna elements—potentially causing harmful feedback that degrades the receive sensitivity. Additionally, because antenna elements with parallel antenna boresights all have maximum gains in the same direction, powering up RFID tags that are off axis from antenna boresights (e.g., RFID tags at more oblique angles/higher elevation angles and longer ranges from the sensor) and detecting weak replies from those RFID tags may be more challenging with a conventional antenna array.

The present disclosure addresses these issues by providing a reader architecture with an antenna array that include antenna elements with antenna boresights that are not parallel to each other. For instance, the antenna elements can be disposed on respective angled facets of a faceted surface (such as a frustum with two base faces and six or nine side faces), a concave or convex surface such as a hemispheric surface, an undulating surface, a smoothly tapering surface, an amorphous surface, and/or a plurality of surfaces. Antenna elements on different facets of a faceted surface have antenna boresights that form angles with each other, which serves to reduce cross-talk and provide higher gain over a wider range of angles including elevation angles to RFID tags at longer ranges from the reader. As an example, an array of six antenna elements with parallel boresights may have an effective detection radius of about 10 meters, while sensors with the same or analogous antenna elements, but having non-parallel boresights (i.e., skew or intersecting boresights, at least some of which may be pointed at angles away from a centerline axis of the sensor) in accordance with the present technology may have effective detection radii of 15-20 meters or more.

Additionally, the present disclosure provides apparatuses and methods for modulating areas of coverage of transmitted signals by activating selected groups of antenna elements in the antenna array, thereby delivering more power to RFID tags for a given number of antenna elements and increasing the likelihood of activating the tags. Put differently, an antenna array with antenna elements having boresights that are not parallel to each other (e.g., antenna elements on a faceted surface) can project more power to RFID tags in a wider array of positions than antenna elements with parallel boresights (e.g., antenna elements in the same plane). This makes it possible to power up (and detect responses from) tags at farther ranges from the antenna array. It also makes it possible to allocate power emissions more efficiently among the antenna elements in the antenna array. The FCC limits the total amount of power emitted by the antenna array, so antenna elements pointing towards a given tag can emit more power and antenna elements pointing in other directions may emit little to no power when attempting to power up that tag. In other words, the (groups of) antenna elements that emit a given signal may be selected to provide a higher likelihood of activating tags within a particular volume relative to the reader, for example, within an arc spanning 60° of a perimeter of a frustum on which the antenna elements are mounted.

In some aspects, the techniques described herein relate to a sensor for locating a radio-frequency identification (RFID) tag, the sensor including: a transceiver to generate at least one interrogation signal and receive at least one reply signal; an antenna array, operably coupled to the transceiver and including antenna elements disposed on respective facets of a faceted surface, to transmit the at least one interrogation signal and detect the at least one reply signal; at least one switch, operably coupled to the transceiver and the antenna array, to communicatively couple one or more of the antenna elements to the transceiver; and a processor, operably coupled to the transceiver and the antenna elements, to determine a location of the RFID tag using one or more reply signals received by the antenna array.

In some aspects, the techniques described herein relate to a sensor, wherein: a baseline antenna element of the antenna array is disposed with a boresight parallel to a centerline axis; and the antenna elements of the antenna array except the baseline antenna element are disposed at an elevation angle with respect to a centerline axis.

In some aspects, the techniques described herein relate to a sensor, wherein: the processor is further configured to command a first subset of antenna elements of the antenna array to transmit first activation signals and a second subset of antenna elements of the antenna array to transmit second activation signals; and the first subset of antenna elements includes the baseline antenna element and the second subset of antenna elements includes the baseline antenna element.

In some aspects, the techniques described herein relate to a sensor, wherein the processor is further configured to: command a subset of antenna elements of the antenna array to transmit first activation signals.

In some aspects, the techniques described herein relate to a method of interrogating a radio-frequency identification (RFID) tag, the method including: generating an interrogation signal at a transceiver; selecting a plurality of antenna elements of an antenna array, each of the plurality of antenna elements disposed on a respective facet of a faceted surface, to communicatively couple to the transceiver using at least one switch; transmitting the interrogation signal by the plurality of antenna elements; and receiving, at the selected plurality of antenna elements, a reply signal from the RFID tag in response to the interrogation signal.

In some aspects, the techniques described herein relate to a method, further including: determining a location of the RFID tag based on the reply signal.

In some aspects, the techniques described herein relate to a method, wherein: a baseline antenna element of the antenna array is disposed with a boresight parallel to a centerline axis; and the antenna elements of the antenna array except the baseline antenna element are disposed with an elevation angle with respect to a centerline axis.

In some aspects, the techniques described herein relate to a method, further including: commanding a first subset of antenna elements of the antenna array to transmit first activation signals and a second subset of antenna elements of the antenna array to transmit second activation signals, wherein; the first subset of antenna elements includes the baseline antenna element and the second subset of antenna elements includes the baseline antenna element.

In some aspects, the techniques described herein relate to a method, further including: commanding, by a processor, a subset of the antenna elements of the antenna array to transmit first activation signals to the RFID tag.

In some aspects, the techniques described herein relate to a method of interrogating a radio-frequency identification (RFID) tag with an antenna array including antenna elements arranged having boresights pointing in different directions, the method including: generating, with a transceiver operably coupled to the antenna array, a first interrogation signal; transmitting the first interrogation signal from a first subset of antenna elements in the antenna array to the RFID tag, the first subset of antenna elements including a first plurality of antenna elements; receiving, by at least the first subset of antenna elements, a first reply to the first interrogation signal from the RFID tag; generating, with the transceiver, a second interrogation signal; transmitting the second interrogation signal from a second subset of antenna elements in the antenna array to the RFID tag, the second subset of antenna elements including a second plurality of antenna elements; and receiving, by at least the second subset of antenna elements, a second reply to the second interrogation signal from the RFID tag.

In some aspects, the techniques described herein relate to a method, wherein the antenna elements are disposed on respective facets of a faceted surface.

In some aspects, the techniques described herein relate to a method, wherein the antenna elements are disposed on respective portions of a surface.

In some aspects, the techniques described herein relate to a method, wherein the antenna elements are disposed on a plurality of surfaces.

In some aspects, the techniques described herein relate to a method, further including: estimating a location of the RFID tag based on the first reply and second reply. 24.

In some aspects, the techniques described herein relate to a method, wherein estimating the location of the RFID tag includes determining phase differences among the antenna elements in the first subset of antenna elements and among antenna elements in the second subset of antenna elements. 26.

In some aspects, the techniques described herein relate to a sensor for interrogating a radio-frequency identification (RFID) tag, the sensor including: a transceiver to generate at least one interrogation signal and receive at least one reply signal; an antenna array, operably coupled to the transceiver and including antenna elements having boresights pointing in different directions, to transmit the at least one interrogation signal and detect the at least one reply signal; at least one switch, operably coupled to the transceiver and the antenna array, to communicatively couple one or more of the antenna elements to the transceiver; and a processor, operably coupled to the transceiver and the antenna elements, to process the at least one reply signal.

In some aspects, the techniques described herein relate to a sensor, wherein the antenna elements are disposed on respective facets of a faceted surface.

In some aspects, the techniques described herein relate to a sensor, wherein the antenna elements are disposed on respective portions of a surface.

In some aspects, the techniques described herein relate to a sensor, wherein the antenna elements are disposed on a plurality of surfaces.

In some aspects, the techniques described herein relate to a sensor, wherein the processor is further configured to estimate a location of the RFID tag based on the at least one reply signal. 32.

In some aspects, the techniques described herein relate to a method for locating a radio-frequency identification (RFID) tag with an antenna array including antenna elements on respective facets of a faceted surface, the method including: generating, with a transceiver operably coupled to the antenna array, a first interrogation signal; transmitting the first interrogation signal from a first subset of antenna elements in the antenna array to the RFID tag, the first subset of antenna elements including a first plurality of antenna elements disposed at an elevation angle with respect to a centerline axis; receiving, by at least the first subset of antenna elements, a first reply to the first interrogation signal from the RFID tag; generating, with the transceiver, a second interrogation signal; transmitting the second interrogation signal from a second subset of antenna elements in the antenna array to the RFID tag, the second subset of antenna elements including a second plurality of antenna elements disposed at the elevation angle with respect to the centerline axis; and receiving, by at least the second subset of antenna elements, a second reply to the second interrogation signal from the RFID tag.

In some aspects, the techniques described herein relate to a method, wherein each antenna element of the first plurality of antenna elements has a different azimuthal angle with respect to the centerline axis.

In some aspects, the techniques described herein relate to a method, wherein each antenna element of the second plurality of antenna elements has a different azimuthal angle with respect to the centerline axis.

In some aspects, the techniques described herein relate to a method, wherein the first plurality of antenna elements and the second plurality of antenna elements have at least one antenna element in common.

In some aspects, the techniques described herein relate to a method, wherein: the first plurality of antenna elements includes a first antenna element, a second antenna element, and a third antenna element; and the second plurality of antenna elements includes the second antenna element, the third antenna element, and a fourth antenna element.

In some aspects, the techniques described herein relate to a method, further including determining that the RFID tag did not move between receiving the first reply and receiving the second reply based on a phase difference between the second antenna element and the third antenna element of the first reply and a phase difference between the second antenna element and the third antenna element of the second reply remaining substantially unchanged.

In some aspects, the techniques described herein relate to a method, wherein: the first antenna element has a first azimuthal angle with respect to the centerline axis; the second antenna element has a second azimuthal angle with respect to the centerline axis; the third antenna element has a third azimuthal angle with respect to the centerline axis; and the fourth antenna element has a fourth azimuthal angle with respect to the centerline axis.

In some aspects, the techniques described herein relate to a method, wherein: the antenna array further includes a baseline antenna element disposed with a boresight parallel to the centerline axis; the first subset of antenna elements includes the baseline antenna element; and the second subset of antenna elements includes the baseline antenna element.

In some aspects, the techniques described herein relate to a method, further including, after receiving the first reply to the first interrogation signal and before generating the second interrogation signal: switching between the first plurality of antenna elements and the second plurality of antenna elements using at least one switch communicatively coupled to the first plurality of antenna elements, the second plurality of antenna elements, and the transceiver.

In some aspects, the techniques described herein relate to a method, further including: estimating a location of the RFID tag based on the first reply and second reply.

In some aspects, the techniques described herein relate to a method, wherein estimating the location of the RFID tag includes determining phase differences among the antenna elements in the first subset of antenna elements and among antenna elements in the second subset of antenna elements.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates a perspective view of an RFID tag reader or sensor with an antenna array that includes antenna elements disposed on different facets of a faceted surface in accordance with the present technology.

FIG. 1B illustrates a plan view of the sensor of FIG. 1A showing an azimuthal angle separating two adjacent antenna elements.

FIG. 1C illustrates a partial cutaway view of the sensor of FIG. 1A showing an elevation angle between an exemplary antenna element and facet of a frustum with respect to a centerline of the sensor.

FIG. 1D illustrates a plan view of the sensor of FIG. 1A showing different subsets of antenna elements and the corresponding directional areas, or sectors, towards which those subsets of antenna elements transmit interrogation signals and receive tag replies.

FIG. 2 is a block diagram of internal circuitry within an exemplary sensor.

FIG. 3 is a block diagram of internal circuitry within an alternative exemplary sensor.

FIG. 4A illustrates a perspective view of the sensor of FIG. 3.

FIG. 4B illustrates a top view of the sensor of FIG. 4A.

FIG. 4C illustrates a side view of the sensor of FIG. 4A.

FIG. 5 is a flowchart of a method for interrogating and optionally locating an RFID tag with an antenna array comprising antenna elements on respective facets of a faceted surface.

FIG. 6 is a flowchart of a method for interrogating and optionally locating an RFID tag.

FIG. 7 is a flowchart of a method for interrogating and optionally locating an RFID tag with an antenna array comprising antenna elements arranged having boresights pointing in different directions.

### DETAILED DESCRIPTION

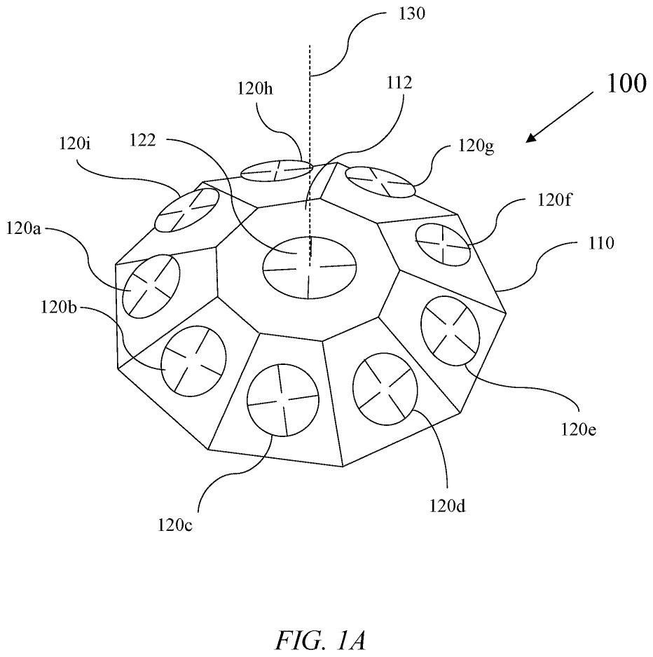

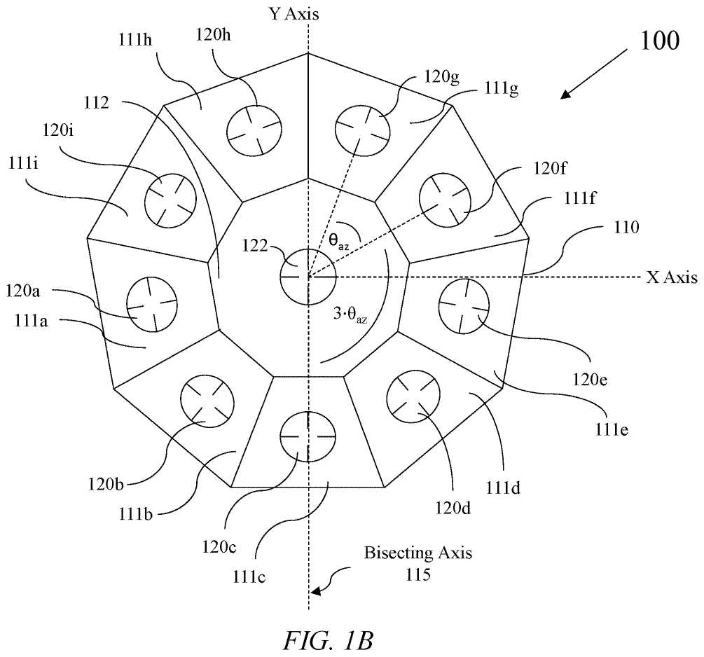

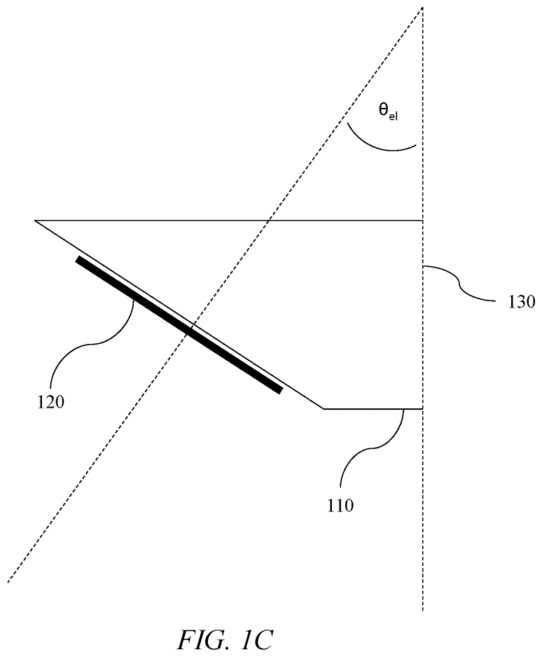

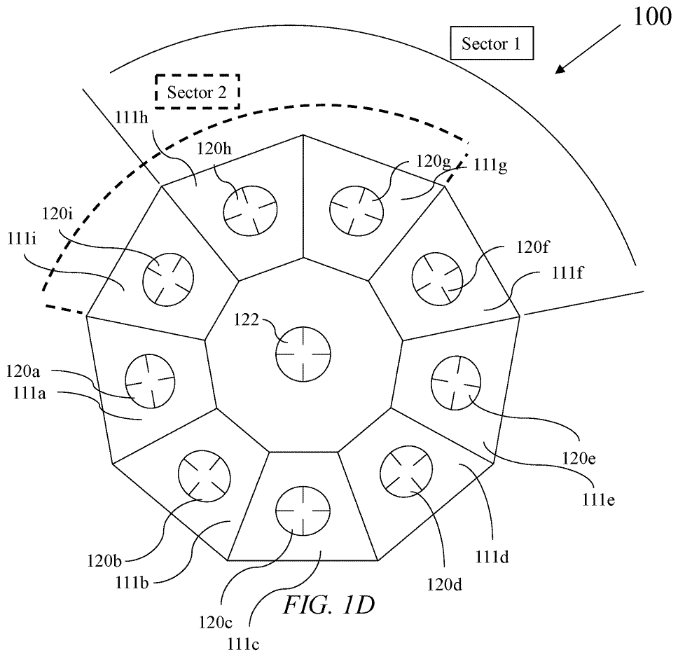

FIGS. 1A-1D illustrate a sensor 100 in accordance with the present technology. Sensor 100 may include a structural element in the shape of a frustum 110 or other faceted surface.
Frustum 110 may be a frustum with nine side faces, which is formed by cutting off the upper part (point) of a nine-sided pyramid at a plane parallel to the pyramid's base. Sensor 100 may include an antenna array with antenna elements 120a-i and baseline antenna element 122 disposed on respective facets 111a-i and 112 of frustum 110. Sensor 100 includes one antenna element per facet, but other sensors may have facets without any antenna elements and/or facets with more than one antenna element. Each of antenna elements 120a-i and baseline antenna element 122 may be disposed parallel to the facet of the frustum on which the antenna element is disposed and accordingly have a boresight angle orthogonal to the surface of the facet. Sensor 100 may include a baseline antenna element 122 disposed on a bottom facet 112 of frustum 110. Baseline antenna element 122 may be disposed orthogonal to a centerline axis 130 of frustum 110 such that the boresight of baseline antenna element 122 is aligned/coaxial with the centerline axis of frustum 110. If the sensor 100 is mounted on the ceiling pointing down toward the floor, then the centerline axis 130 may be referred to as the z axis. Bottom facet 112 may be substantially parallel to a floor, ceiling, or other surface of a location in which sensor 100 is disposed.

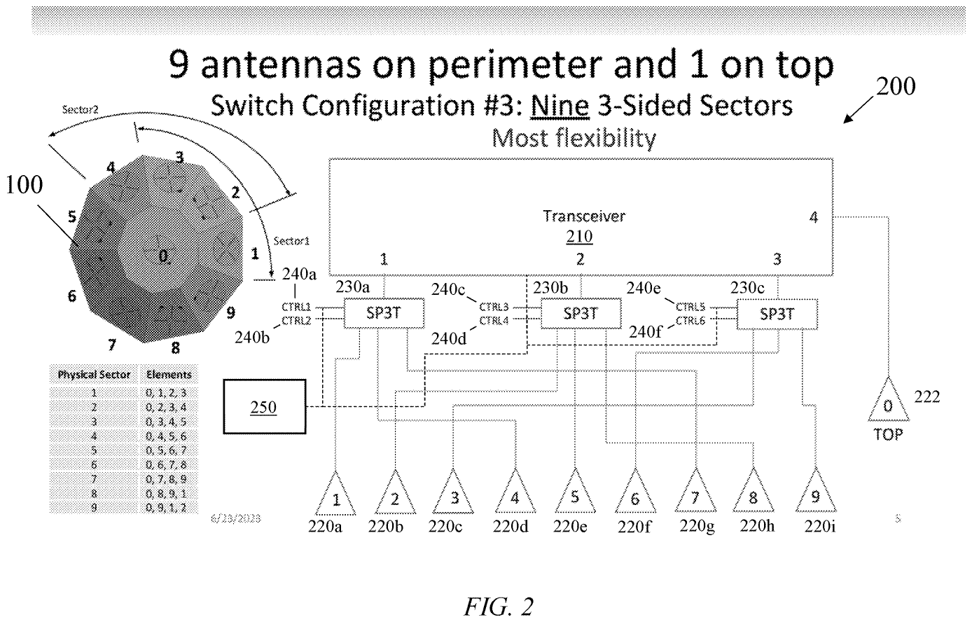

Frustum 110 may house various electronics or circuitry such as one or more processors, one or more controllers, one or more switches, one or more transceivers, and the like. A material of frustum 110 may be chosen to be substantially opaque to radio or other electromagnetic waves. Frustum 110 may house one or more elements described below with reference to FIG. 2. An additional covering or housing, such as a radome (not shown), may substantially cover frustum 110. The radome is made of a material that is substantially transparent to the RF signals transmitted and received by the antenna elements 120 and 122 (i.e., the radome does not absorb, reflect, or attenuate radiation in the RFID band(s)). The radome can be faceted, curved, or have any other suitable shape.

Each of antenna elements 120a-i may be disposed at one or more angles with respect to the centerline axis 130 of frustum 110. The angles may include an azimuthal angle θ_{az} and an elevation angle θₑₗ. Each antenna element 120a-i may be disposed with the same elevation angle θₑₗ with respect to a centerline axis 130 of the frustum. Each antenna element 120a-i may be disposed at an azimuthal angle with respect to a bisecting axis such as bisecting axis 115 (shown in FIG. 1B) of the frustum such that each individual antenna element 120a-i is disposed at a multiple of a reference azimuthal angle with respect to bisecting axis 115. Equivalently, each antenna element (as well as each facet of frustum 110) may be separated from adjacent antenna elements and facets by reference azimuthal angle θ_{az}. FIG. 1B illustrates a reference azimuthal angle θ_{az} separating two adjacent antenna elements 120g and 120f.

FIG. 1C is a partial cross section illustrating an elevation angle θₑₗ at which an exemplary antenna element 120 (and facet of frustum 110) is disposed with respect to the centerline axis 130. θₑₗ may be formed by the intersection of centerline axis 130 with a line perpendicular to the center of a facet on which antenna element 120 is disposed. An elevation angle θₑₗ may be selected based on a predetermined transmission power and anticipated elevation of RFID tags above or below a reference surface such as a floor or ceiling of a room in which sensor 100 is located. In a conventional reader, antenna elements are typically arranged in a planar array with boresights pointed in the same direction, e.g., straight down at the floor or rather than in different directions or at different boresight angles. Because the antenna elements in a conventional reader point in the same direction, they cannot provide a 360° view like the reader 100 of FIGS. 1A-1D.

Angling facets of frustum 110 and antenna elements 120 disposed on the facets 111 based on angles θ_{az} and θₑₗ may have the additional benefit of separating and/or de-parallelizing adjacent antenna element boresights. This may reduce or prevent undesirable cross-talk between adjacent antenna elements and enable a more accurate reading of RFID tags, longer range, and improved sensitivity. Further, this may allow for a wider detection area and/or improved accuracy of location determination because an RFID tag at any given location may receive signals from a plurality of antenna elements. A subset of antenna elements (for example, three antenna elements, four antenna elements, five antenna elements, etc.) may transmit interrogation signals substantially simultaneously (in some cases with minor phase delays for beam steering and constructive interference purposes), which may provide increased activation signal power to a target RFID tag when compared to a single antenna element transmitting at the same power as any one of the four antenna elements.

An elevation angle at which antenna elements 120a-i are disposed may be chosen to increase the likelihood of detecting a response from RFID tags at a certain height above a floor or a certain height below a ceiling. For example, sensor 100 may be located on a ceiling of a retail store. Merchandise within the retail store may be outfitted with RFID tags, which may be generally placed between 5 and 7 feet below the ceiling. An elevation angle at which antenna elements 120a-i are disposed may be chosen to maximize a projected power level between 5 and 7 feet below the ceiling within a particular radius of sensor 100.

FIG. 1D illustrates exemplary directional areas or sectors towards which one or more interrogation signals may be sent by transmitting from multiple antenna elements at the same time. For example, sensor 100 may transmit interrogation signals from antenna elements 120f, 120g, 120h, and 122 simultaneously, which may result in RFID tags located in sector 1 receiving sufficient power to activate and transmitting one or more reply signals. The same antenna elements 120f, 120g, 120h, and 122 detect the replies from the RFID tags in sector 1. Similarly, sensor 100 may further transmit a second interrogation signal from antenna elements 120g, 120h, 120i, and 122, which may result in RFID tags located in sector 2 transmitting one or more reply signals. These reply signals may then be detected by antenna elements 120g, 120h, 120i, and 122.

FIG. 2 shows internal circuitry 200 within an exemplary sensor such as sensor 100. Internal circuitry 200 may include transceiver 210. Transceiver 210 may be configured to send and receive signals through antenna elements 220a-i and baseline antenna element 222. Antenna elements 220a-i may be analogous to antenna elements 120a-i in sensor 100. Baseline antenna element 222 may be analogous to baseline antenna element 122 in sensor 100.

Internal circuitry 200 may include single-pole, triple-throw (SP3T) switches 230a-c (e.g., with an isolation between active and non-active signal paths of 40 dB or more). Switch 230a may be operably coupled to three antenna elements, for example 220a, 220d, and 220g. Switch 230a may be operably coupled to three antenna elements disposed with equal angular spacing around a perimeter of frustum 110. Switch 230b may be operably coupled to three antenna elements, for example, antenna elements 220b, 220e, and 220h. Switch 230b may be operably coupled to three antenna elements disposed with equal angular spacing around a perimeter of frustum 110. Switch 230c may be operably coupled to three antenna elements, for example, antenna elements 220c, 220f, and 220i. Switch 230c may be operably coupled to three antenna elements disposed with equal angular spacing around a perimeter of frustum 110. Baseline antenna element 222 may be coupled directly to transceiver 210 and transmit all signals output by transceiver 210.

Switches 230a-c may provide a communicative coupling from transceiver 210 to antenna elements 220a-i. Switches 230a-c may control the transmission of an interrogation or similar signal generated by transceiver 210 by communicatively coupling transceiver 210 with one or more antenna elements 210a-i. A signal generated by transceiver 210 may be transmitted to switches 230a-c. Switches 230a-c may then transmit the generated signal to one of the antenna elements to which it is connected. For example, a signal generated by transceiver 210 may be transmitted to antenna element 220a by switch 230a, to antenna element 220b by switch 230b, and antenna element 220c by switch 230c. Additionally, the signal may be transmitted to baseline antenna element 222. The signal may then be broadcast by antenna elements 220a-c and 222.

The transceiver 210 can send the same signal, at the same power level, to the baseline antenna element 222 and to each switch 230 (and hence to each of the radiating antenna elements 220). In other words, the transceiver 210 can generate a signal, then split it equally into four components with an internal or external 1×4 RF power splitter (not shown), with one output of the RF power splitter coupled to the baseline antenna element 222 and each other output is coupled to a different switch 230. Alternatively, the transceiver 210 can couple different amounts of RF power to the different outputs of the 1×4 RF power splitter, e.g., 10% to the baseline antenna element 222 and 30% to each switch 230. These splitting ratios can be fixed, e.g., with fixed attenuators or splitters, or variable, e.g., using variable attenuators or splitters. If the splitting ratio is variable, it can be controlled based on the area or sector being probed by the sensor 200, For instance, if the sensor is trying to interrogate an RFID tag at a very oblique angle, the transceiver 210 may direct more RF power to the switch(es) 230 and antenna element(s) 220 pointing at the RFID tag and less RF power to the other switch(es) 230, antenna element(s) 220, and baseline antenna element 222. In some cases, the transceiver 210 can even generate different signals to be emitted by different antenna elements 220, 222, depending on the sensor's operation, such as whether the sensor 200 is tasked with locating an RFID tag or simply interrogating an RFID tag.

Switches 230a-c may have one or more inputs such as control inputs 240a-f. Control inputs 240a-f may be connections from switches 230a-c to one or more processors or controllers such as processor 250 that function to operate sensor 100 and/or internal circuitry 200. Control inputs 240a-f may control which antenna elements are communicatively coupled to transceiver 210. For example, control inputs 240a-f may allow a signal generated by transceiver 210 to be transmitted to antenna elements 220a, 220b, and 220c, but prevent the signal from being transmitted to antenna elements 220d-i. Analogously, control inputs 240a-f may control which signals received by antenna elements 220a-i may be transmitted to transceiver 210 and/or to processor 250 communicatively coupled to internal circuitry 200. This may allow sensor 100 and/or internal circuitry 200 to reduce unwanted noise from unintended or undesirable sources and boost a signal-to-noise ratio (SNR) by combining reply signals detected by multiple antenna elements.

RFID tags within receiving range of one or more transmitted signals may reply to one or more transmitted interrogation signals by sending one or more reply signals. These reply signals may be received by one or more antenna elements in sensor 100 and/or internal circuitry 200. A reply signal transmitted by an RFID tag may be received by the same antenna elements that transmitted the interrogation signal. The reply signal detected by respective antenna elements may subsequently be transmitted to transceiver 210 and then forwarded to processor 250 for processing. The processor 250 may optionally analyze the reply signal(s) to estimate or determine a location of the RFID tag.

An RFID tag may include an antenna (for example, a dipole antenna) that may radiate the reply signal in a donut-shaped pattern. Because the antenna elements 220a-i and baseline antenna element 222 are at different locations with respect to an RFID tag, this RF field may impinge each reader antenna element at a different phase compared to the other reader antenna elements, as well as potentially from a different azimuth and/or elevation. The processor 250 can calculate the corresponding phase and/or angle differences between reader antenna elements to determine AOAs and transmit the calculated AOAs for each RFID tag to the processor 250. The processor 250 may aggregate the AOAs from activated antenna elements and use them to estimate the tag's location, e.g., by trilateration or triangulation. Additionally or alternatively, processor 250 may calculate RFID tag distance and/or location using one or more sensors by performing a delta-frequency and/or delta-phase calculation. With more AOA measurements (including more AOA measurements from a larger number of antenna elements for a single RFID tag reply signal), processor 250 can estimate the tag's location relative to the antenna elements 220a-i and baseline antenna element 222 more precisely. If the readers'locations are known, processor 250 can use them to estimate the tag's absolute location as well.

Processor 250 can also estimate tag locations using channel estimates that characterize the communications channels between sensor 100 and the tags. Because the different antenna elements 220 and 222 face in different directions, the signals that travel along communications channels between those antenna elements 220 and 222 and a given tag may experience different types and amounts of attenuation and distortion. Thus, each antenna element 220, 222 or subset of antenna elements 220, 222 may have a different channel estimate to a given tag. For more on using channel estimates to locate RFID tags, please see International Application No. PCT/US 2024/020357, filed on Mar. 18, 2024, and entitled “Channel Estimation for Locating RFID Tags,” which is incorporated herein by reference in its entirety for all purposes.

FIG. 2 further illustrates physical sectors 1-9 each including a different combination of channels or antenna elements. Each of physical sectors 1-9 include the baseline antenna element (labeled 0 in FIG. 2) and three of antenna elements 1-9. Each antenna element 0-9 (along with switches 230a-c) provides a communication channel between an RFID tag and a transceiver or processor. Antenna elements 1-9 may be angled with respect to a horizontal plane, allowing antenna elements 0-9 to transmit increased signal power to RFID tags not located directly underneath sensor 100. A transceiver may have a limited number of channels, such as four channels, available to read signals and replies received by antenna elements 0-9. Switches 230a-c may allow sensor 100 to utilize more antenna elements than total transceiver channels by switching between multiple subsets of up to four antenna elements to be communicatively coupled with transceiver 210 at a given time.

Utilizing dynamically created groups of antenna elements may increase efficiency for determining tag location. For example, when determining if an RFID tag is stationary, a first group of antenna elements including baseline antenna element 222 and a plurality of additional antenna elements (e.g., antenna elements 220a-c) may transmit an interrogation signal and receive a first reply signal from an RFID tag. Processor 250 may then calculate phase differences between one or more pairs of antenna elements of the first group of antenna elements (e.g., the phase difference between antenna elements 220b-c). A second group of antenna elements including baseline antenna element 222 and a second plurality of additional antenna elements may then transmit a second interrogation signal and receive a second reply signal from the RFID tag. The second group of additional antenna elements may include several antenna elements from the first group of antenna elements (e.g., the second group may include antenna elements 220b-d such that both the first group and the second group include antenna elements 220b-c).

Processor 250 may then calculate a phase difference of the first reply between antenna elements 220b and 220c and calculate a phase difference of the second reply between antenna elements 220b and 220c. If the phase difference between antenna elements 220b and 220c remains substantially unchanged during both the first reply and the second reply, processor 250 may determine that the RFID tag has not moved, and no further calculation is necessary. Processor 250 can also compute the AOA of the RFID tag's replay based on a union of the phases from multiple antenna elements 220 and 222.

Processor 250 may compare phase differences between replies received by a plurality of antenna elements. For example, processor 250 may compare phase differences of first and second replies between two antenna elements, three antenna elements, four antenna elements, or any suitable number of antenna elements. Processor 250 may additionally or alternatively compare phase differences between replies received by baseline antenna element 222 and any one or more of antenna elements 220a-i.

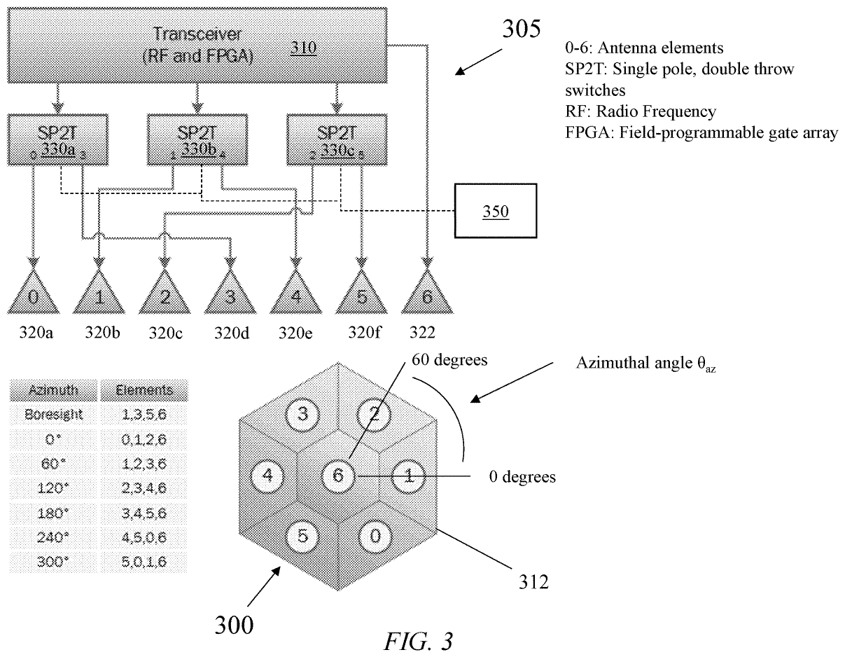

FIG. 3 shows internal circuitry 305 within an exemplary seven-element sensor 300. Sensor 300 may include one or more antenna elements disposed on respective facets of a frustum 312 with six side faces. Internal circuitry 305 housed inside frustum 312 may include transceiver 310. Transceiver 310 may be configured to send and receive signals through antenna elements 320a-f and baseline antenna element 322. Like transceiver 210, transceiver 310 can be configured to provide the same RFID signal at equal RF power levels to the different antenna elements 320, 322, the RFID signal at different (fixed or variable) RF power levels to the different antenna elements 320, 322, or even different signals to the to the different antenna elements 320, 322. Antenna elements 320a-f may be analogous to antenna elements 120a-f in sensor 100. Baseline antenna element 322 may be analogous to baseline antenna element 122 in sensor 100. Sensor 300 may be analogous to sensor 100 with analogous changes to spacing and azimuthal angles in accordance with the reduced number of angled facets of frustum 312 as compared to frustum 110.

Internal circuitry 305 may include single-pole, double-throw (SP2T) switches 330a-c. Switch 330a may be operably coupled to two antenna elements, for example 320a and 320 d. Switch 330a may be operably coupled to two antenna elements disposed with equal angular spacing around a perimeter of frustum 312. Switch 330b may be operably coupled to two antenna elements, for example, antenna elements 320b and 320e. Switch 330b may be operably coupled to two antenna elements disposed with equal angular spacing around a perimeter of frustum 312. Switch 330c may be operably coupled to two antenna elements, for example, antenna elements 320c and 320f. Switch 330c may be operably coupled to two antenna elements disposed with equal angular spacing around a perimeter of frustum 312. Baseline antenna element 322 may be coupled directly to transceiver 310 and transmit all signals output by transceiver 310. Other sensors may have different numbers of antenna elements and different numbers and types of switches. For example, the present technology may include single-pole, quadruple-throw (SP4T) switches coupled to up to four antenna elements each.

Switches 330a-c may provide a communicative coupling from transceiver 310 to antenna elements 320a-f. Switches 330a-c may control the transmission of an interrogation or similar signal generated by transceiver 310 by communicatively coupling transceiver 310 with one or more antenna elements 310a-f. A signal generated by transceiver 310 may be transmitted to switches 330a-c. Switches 330a-c may then transmit the generated signal to one of the antenna elements to which it is connected. For example, a signal generated by transceiver 310 may be transmitted to antenna element 320a by switch 330a, to antenna element 320b by switch 330b, and antenna element 320c by switch 330c. Additionally, the signal may be transmitted to baseline antenna element 322. The signal may then be broadcast by antenna elements 320a-c and 322.

Switches 330a-c may have one or more inputs such as control inputs 340a-f. Control inputs 340a-f may be connections from switches 330a-c to one or more processors or controllers such as processor 350 that function to operate sensor 100 and/or internal circuitry 305. Control inputs 340a-f may control which antenna elements are communicatively coupled to transceiver 310. For example, control inputs 340a-f may allow a signal generated by transceiver 310 to be transmitted to antenna elements 320a, 320b, and 320c, but prevent the signal from being transmitted to antenna elements 320d-f. Analogously, control inputs 340a-f may control which signals received by antenna elements 320a-f may be transmitted to transceiver 310 and/or to processor 250 communicatively coupled to internal circuitry 305. This may allow sensor 300 and/or internal circuitry 305 to reduce unwanted noise from unintended or undesirable sources and boost the SNR by combining reply signals detected by multiple antenna elements.

An RF field from an RFID tag or other transmitter may impinge each reader antenna element of sensor 300 at a different phase compared to the other reader antenna elements, as well as potentially from a different azimuth and/or elevation. The processor 350 can calculate the corresponding phase and/or angle differences between reader antenna elements to determine AOAs and transmit the calculated AOAs for each RFID tag to processor 350. Processor 350 may aggregate the AOAs from activated antenna elements and use them to estimate the tag's location, e.g., by trilateration or triangulation. AOAs from an RFID tag to several sensors can also be used to estimate that RFID tag's location. Additionally or alternatively, processor 350 may calculate RFID tag distance and/or location using one or more sensors by performing a delta-frequency and/or delta-phase calculation. With more AOA measurements (including more AOA measurements from a larger number of antenna elements for a single RFID tag reply signal), processor 350 can estimate the tag's location relative to the antenna elements 320a-f and baseline antenna element 322 more precisely. If the readers'locations are known, processor 350 can use them to estimate the tag's absolute location as well.

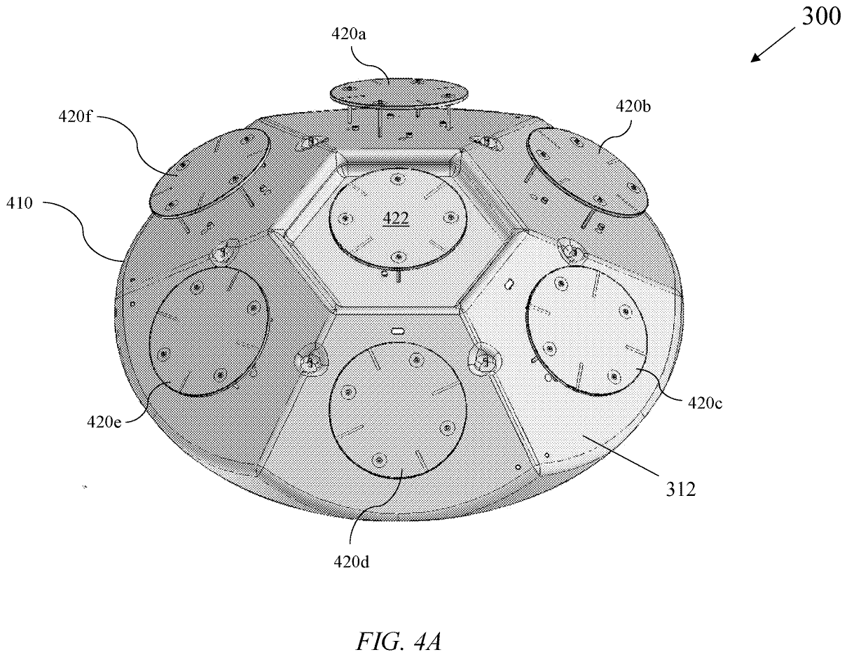

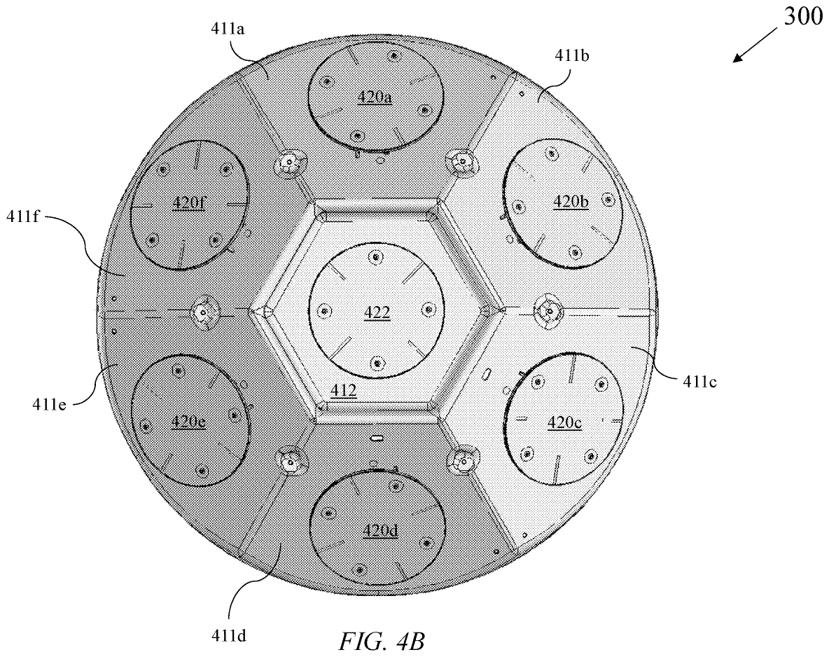

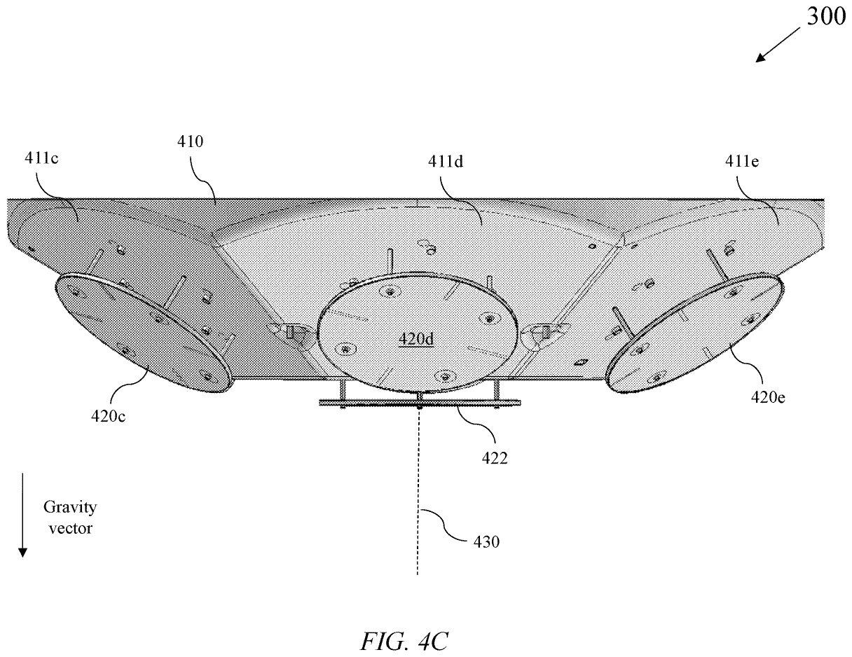

FIGS. 4A-4C show additional details of sensor 300. Sensor 300 may include analogous components to that of sensor 100, including a multi-sided frustum 410 having a plurality of angled facets 411a-f. In an aspect, sensor 300 may include six facets that have an elevation angle with respect to a centerline axis, for example, as depicted in FIG. 1C, as well as a bottom facet 412 analogous to bottom facet 112 of sensor 100. Each facet 411a-f may include a corresponding antenna element 320a-f. FIG. 4A illustrates an isometric view of sensor 300 including raised antenna elements 320a-f. Each antenna element of antenna elements may further be disposed at an azimuthal angle θ_{az} with respect to a bisecting axis, e.g., 60° as illustrated in FIG. 3.

As with frustum 110, frustum 410 may house various electronics or circuitry used by the sensor 300 including one or more processors, one or more controllers, one or more switches, one or more transceivers, and the like. A material of frustum 410 may be chosen to be substantially opaque to radio or other electromagnetic waves. Frustum 410 may additionally or alternatively house one or more elements described above with reference to FIG. 3, including single pole-double throw (SP2T) switches.

Sensor 300 may further include a baseline antenna element 322 disposed on a bottom facet 412 of frustum 410. In an aspect, a boresight of baseline antenna element 322 (which may be parallel to centerline axis 430) may be substantially aligned with a gravity vector.

When compared with a sensor having a greater number of antenna elements (e.g., sensor 100), sensor 300 may provide advantages of decreased system complexity, lower cost, fewer constituent parts, and a smaller footprint (e.g., smaller volume and/or mounted surface area).

Those of ordinary skill in the art will appreciate that the sensors shown in FIGS. 1A-1D, 2, 3, and 4A-4C and described above are examples and that other sensors and sensing techniques are possible. For instance, an inventive sensor may have more or fewer antenna elements distributed over more or fewer facets. There may be multiple antenna elements per facet or more facets than antenna elements (in which case not every facet may have an antenna element) or facets with different shapes (e.g., triangles, quadrilaterals, pentagons, hexagons, etc.). The facets may be arranged in a single tier as in FIGS. 1A-1D or in multiple tiers, e.g., on facets of a portion of a truncated icosahedron or other portion of a polyhedron, in which case the antenna boresights may be oriented at different elevation angles. Besides the convex surfaces like those shown in FIGS. 1A-1D, other suitable surfaces can be concave or corrugated. For instance, the antenna elements can be mounted on facets of a concave facets surfaces that sits in or above an opening in a drop ceiling. The allows the antenna elements to point in different directions without protruding below the ceiling,

The antenna array can be a regular array or a sparse array (e.g., without an antenna element on every facet). The sensor may or may not have an antenna element arranged to point directly down when the sensor is mounted or hung from the ceiling. The number of antenna elements in the antenna array can vary with the size, location, and orientation of the sensor; for example, the antenna array may have 4, 5, 6, 7, 8, 9, 10, 11, 12, 15, 18, or more than 18 antenna elements.

Likewise, the number of channels and switches for generating interrogation signals and processing replies can vary depending on the sensor's desired size, weight, power, and/or performance. Some sensors may have a dedicated channel for each antenna element (and no switches). Some sensors may have one or more channels that are dedicated to one or more corresponding antenna elements (e.g., as in FIG. 2). Other sensors may have 2, 3, 4, 5, or more channels for a greater number of antenna elements with switches for selectively coupling the sensors to the channels as described above. A sensor may include as many channels as elements, for example, 4 channels and 4 antenna elements, 6 channels and 6 antenna elements, 9 channels and 9 antenna elements, and so on.

The number of transmit (Tx) channels and the number of receive (Rx) channels within a sensor may be equal or may differ. A sensor may include phase shifters for beam steering, with one phase shifter communicatively coupled to each antenna element. For a stationary tag, a processor such as processor 250 may calculate an improved AOA (as compared to a sensor having an equivalent number of Rx channels as antenna elements) by receiving responses on more Rx channels than there are Tx channels and combining the received signals to increase the SNR. For example, the SNR may increase by about 3 dB by doubling the number of Rx channels.

A further benefit of a sensor having antenna elements on different facets of a frustum or other faceted surface may include improved signal reception for multipath signal detection and analysis. With existing sensor technology, antenna elements are mounted with the boresight of each antenna element facing in the same direction, often aligned with a gravity vector. However, each antenna element of sensors 100 and 400 has a boresight pointing in a unique direction, with a result that incident signals that do not align well with boresights of one or more antenna elements of an example sensor may align well with a boresight of another antenna element of the same sensor. This increased likelihood that an incident signal will have a line-of-sight (LoS) path to at least one antenna element, increasing the likelihood of detecting the incident signal.

In an aspect, a processor of sensor 400 (e.g., processor 350) may cause a first subset of antenna elements 420a-f to transmit a first interrogation signal to an RFID tag. For example, a first subset of antenna elements 420a-f may include antenna element 420a, antenna element 420b, and antenna element 420c. The first subset of antenna elements may additionally include baseline antenna element 422. Upon receiving a response from the RFID tag (or if no response is received), the processor of sensor 400 may cause a second subset of antenna elements 420a-f to transmit a second interrogation signal to the RFID tag.

The first subset of antenna elements and the second subset of antenna elements may include the same number of antenna elements or different numbers of antenna elements and may have at least one antenna element in common. For example, the second subset of antenna elements may include at least one antenna element of the first subset of antenna elements, and includes at least one antenna element not in the first subset of antenna elements. The second subset of antenna elements may optionally include the baseline antenna element. For example, the second subset of antenna elements may include antenna element 420b, antenna element 420c, and antenna element 420d.

Processor 350 can also form a union of tag replies acquired with different subsets of antenna elements. For instance, the replies detected by the first and second subsets of antenna elements can be averaged to suppress noise and increase signal fidelity. They can also be used to estimate the tag's location more accurately, either by using the (different) channel estimates associated with the first and second subsets of antenna elements or by forming a union of the phase measurements by the antenna elements using the common antenna element(s) as a phase reference. Processor 350 can use this union to compute an estimate of the tag's location with finer spatial resolution. Put differently, combining the measurements from different subsets of antenna elements increases the length or aperture size of the antenna array, much like in a synthetic aperture radar, which in turn improves the spatial resolution of the resulting location estimates.

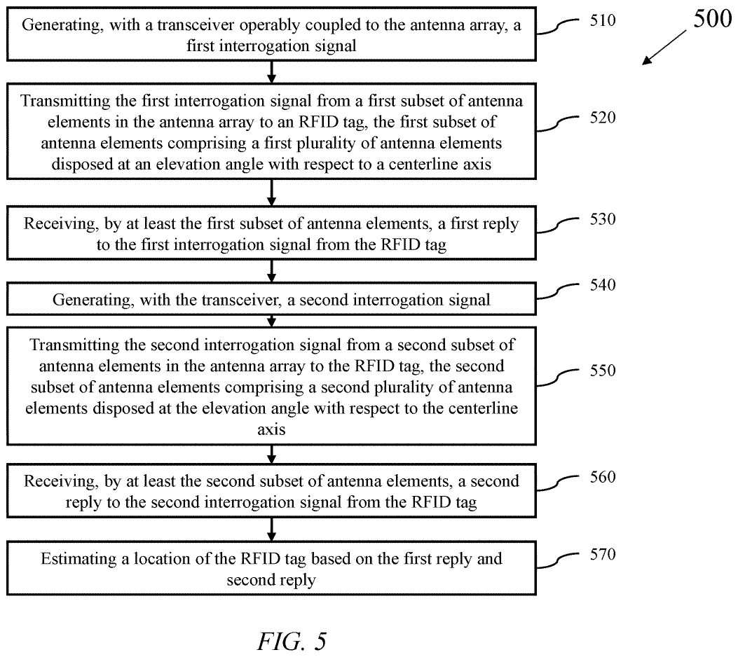

FIG. 5 is a flowchart of an example method 500 for interrogating and optionally locating an RFID tag with an antenna array comprising antenna elements on respective facets of a faceted surface. Method 500 includes blocks 510-560 and may optionally include block 570.

Block 510 includes generating, with a transceiver operably coupled to the antenna array, a first interrogation signal.

Block 520 includes transmitting the first interrogation signal from a first subset of antenna elements in the antenna array to the RFID tag, the first subset of antenna elements comprising a first plurality of antenna elements disposed at an elevation angle with respect to a centerline axis. The first subset of antenna elements may include a first antenna element, a second antenna element, and a third antenna element. In an aspect, the first subset of antenna elements may include a baseline antenna element. Each antenna element of the first plurality of antenna elements may have a different azimuthal angle with respect to a centerline axis. The first antenna element may have a first azimuthal angle with respect to the centerline axis. The second antenna element may have a second azimuthal angle with respect to the centerline axis. The third antenna element may have a third azimuthal angle with respect to the centerline axis. The fourth antenna element may have a fourth azimuthal angle with respect to the centerline axis.

Block 530 includes receiving, by at least the first subset of antenna elements, a first reply to the first interrogation signal from the RFID tag. Block 530 may further include, after receiving the first reply to the first interrogation signal and before generating the second interrogation signal, switching between the first plurality of antenna elements and the second plurality of antenna elements using at least one switch communicatively coupled to the first plurality of antenna elements, the second plurality of antenna elements, and the transceiver.

Block 540 includes generating, with the transceiver, a second interrogation signal.

Block 550 includes transmitting the second interrogation signal from a second subset of antenna elements in the antenna array to the RFID tag, the second subset of antenna elements comprising a second plurality of antenna elements disposed at the elevation angle with respect to the centerline axis. The second plurality of antenna elements may include the second antenna element, the third antenna element, and a fourth antenna element. The second subset of antenna elements may include the baseline antenna element. The baseline antenna element may be disposed with a boresight parallel to the centerline axis.

Block 560 includes receiving, by at least the second subset of antenna elements, a second reply to the second interrogation signal from the RFID tag.

Optional block 570 includes estimating a location of the RFID tag based on the first reply and second reply. Block 570 may further include determining that the RFID tag did not move between receiving the first reply and receiving the second reply based on a phase difference between the second antenna element and the third antenna element of the first reply and a phase difference between the second antenna element and the third antenna element of the second reply remaining substantially unchanged. Block 570 may also include combining phase measurements derived from the first and second replies, with phase measurements by the common antenna element(s) (here, the second, third, and fourth antenna elements) providing a reference for combination, to produce a location estimate with finer spatial resolution than either the first or second subsets of antenna elements alone.

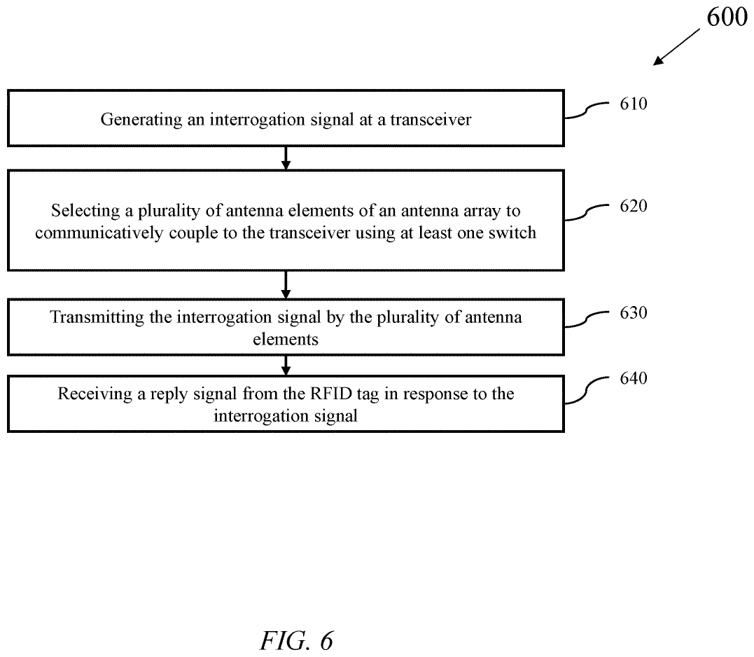

FIG. 6 is a flowchart of an example method 600 for interrogating and optionally locating an RFID tag. Method 600 includes blocks 610-640.

Block 610 includes generating an interrogation signal at a transceiver.

Block 620 includes selecting a plurality of antenna elements of an antenna array, each of the plurality of antenna elements disposed on a respective facet of a faceted surface, to communicatively couple to the transceiver using at least one switch. Selecting the plurality of antenna elements of the antenna array may be performed by a processor communicatively coupled to the switch and/or the plurality of antenna elements. A baseline antenna element of the antenna array may be disposed with a boresight parallel to a centerline axis. The antenna elements of the antenna array except the baseline antenna element may be disposed with an elevation angle with respect to a centerline axis.

Block 630 includes transmitting the interrogation signal by the plurality of antenna elements. Block 630 may further include commanding a first subset of antenna elements of the antenna array to transmit first activation signals and a second subset of antenna elements of the antenna array to transmit second activation signals. The first subset of antenna elements may include the baseline antenna element and the second subset of antenna elements may include the baseline antenna element.

Block 640 includes receiving a reply signal from the RFID tag in response to the interrogation signal. Block 640 may further include determining, by a processor, a location of the RFID tag based on the reply signal. Determining a location of the RFID tag based on the reply signal may include averaging a plurality of replies from the RFID tag to increase a signal-to-noise ratio of the responses and improve the location accuracy of the RFID tag.

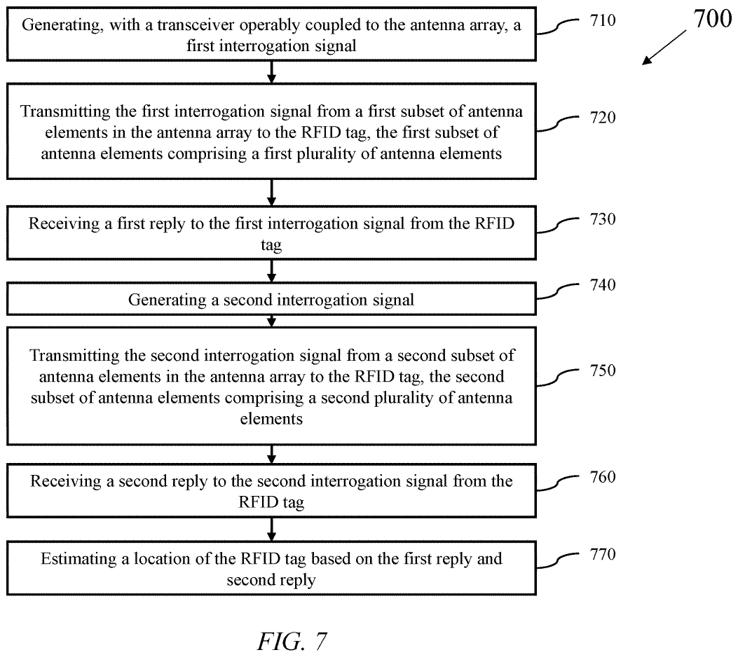

FIG. 7 is a flowchart of an example method 700 for interrogating and optionally locating an RFID tag with an antenna array comprising antenna elements arranged having boresights pointing in different directions. Method 700 includes blocks 710-760 and may optionally include block 770.

Block 710 includes generating, with a transceiver operably coupled to an antenna array, a first interrogation signal.

Block 720 includes transmitting the first interrogation signal from a first subset of antenna elements in the antenna array to the RFID tag, the first subset of antenna elements comprising a first plurality of antenna elements. The antenna elements may be disposed on respective facets of a faceted surface. Additionally or alternatively, the antenna elements may be disposed on respective portions of a surface, or on a plurality of surfaces. The first subset of antenna elements may include a first antenna element, a second antenna element, and a third antenna element. In an aspect, the first subset of antenna elements may include a baseline antenna element. Each antenna element of the first plurality of antenna elements may have a different azimuthal angle with respect to a centerline axis. The first antenna element may have a first azimuthal angle with respect to the centerline axis. The second antenna element may have a second azimuthal angle with respect to the centerline axis. The third antenna element may have a third azimuthal angle with respect to the centerline axis. The fourth antenna element may have a fourth azimuthal angle with respect to the centerline axis.

Block 730 includes receiving, by at least the first subset of antenna elements, a first reply to the first interrogation signal from the RFID tag.

Block 740 includes generating, with the transceiver, a second interrogation signal.

Block 750 includes transmitting the second interrogation signal from a second subset of antenna elements in the antenna array to the RFID tag, the second subset of antenna elements comprising a second plurality of antenna elements.

Block 760 includes receiving, by at least the second subset of antenna elements, a second reply to the second interrogation signal from the RFID tag.

Optional block 770 includes estimating a location of the RFID tag based on the first reply and second reply. Block 770 may further include averaging the first reply and the second reply to improve a signal-to-noise ratio. Block 770 may further include improving a location accuracy of the RFID tag by averaging the first reply, the second reply, and a plurality of third replies to further improve the signal-to-noise ratio of the replies.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A sensor for locating a radio-frequency identification (RFID) tag, the sensor comprising:
a transceiver to generate at least one interrogation signal and receive at least one reply signal;
an antenna array, operably coupled to the transceiver and comprising antenna elements disposed on respective facets of a faceted surface, to transmit the at least one interrogation signal and detect the at least one reply signal;
at least one switch, operably coupled to the transceiver and the antenna array, to communicatively couple one or more of the antenna elements to the transceiver; and
a processor, operably coupled to the transceiver and the antenna elements, to determine a location of the RFID tag using one or more reply signals received by the antenna array.

2. The sensor of claim 1, wherein:
a baseline antenna element of the antenna array is disposed with a boresight parallel to a centerline axis; and
the antenna elements of the antenna array except the baseline antenna element are disposed at an elevation angle with respect to a centerline axis.

3. The sensor of claim 2, wherein:
the processor is further configured to command a first subset of antenna elements of the antenna array to transmit first activation signals and a second subset of antenna elements of the antenna array to transmit second activation signals; and
the first subset of antenna elements comprises the baseline antenna element and the second subset of antenna elements comprises the baseline antenna element.

4. The sensor of claim 1, wherein the processor is further configured to:
command a subset of antenna elements of the antenna array to transmit first activation signals.

5. A method of interrogating a radio-frequency identification (RFID) tag, the method comprising:
generating an interrogation signal at a transceiver;
selecting a plurality of antenna elements of an antenna array, each of the plurality of antenna elements disposed on a respective facet of a faceted surface, to communicatively couple to the transceiver using at least one switch;
transmitting the interrogation signal by the plurality of antenna elements; and
receiving, at the selected plurality of antenna elements, a reply signal from the RFID tag in response to the interrogation signal.

6. The method of claim 5, further comprising:
determining a location of the RFID tag based on the reply signal.

7. The method of claim 5, wherein:
a baseline antenna element of the antenna array is disposed with a boresight parallel to a centerline axis; and
the antenna elements of the antenna array except the baseline antenna element are disposed with an elevation angle with respect to a centerline axis.

8. The method of claim 7, further comprising:
commanding a first subset of antenna elements of the antenna array to transmit first activation signals and a second subset of antenna elements of the antenna array to transmit second activation signals,
wherein the first subset of antenna elements comprises the baseline antenna element and the second subset of antenna elements comprises the baseline antenna element.

9. The method of claim 5, further comprising:
commanding, by a processor, a subset of the antenna elements of the antenna array to transmit first activation signals to the RFID tag.

10. A method of interrogating a radio-frequency identification (RFID) tag with an antenna array comprising antenna elements arranged having boresights pointing in different directions, the method comprising:
generating, with a transceiver operably coupled to the antenna array, a first interrogation signal;
transmitting the first interrogation signal from a first subset of antenna elements in the antenna array to the RFID tag, the first subset of antenna elements comprising a first plurality of antenna elements;
receiving, by at least the first subset of antenna elements, a first reply to the first interrogation signal from the RFID tag;
generating, with the transceiver, a second interrogation signal;
transmitting the second interrogation signal from a second subset of antenna elements in the antenna array to the RFID tag, the second subset of antenna elements comprising a second plurality of antenna elements; and
receiving, by at least the second subset of antenna elements, a second reply to the second interrogation signal from the RFID tag.

11. The method of claim 10, wherein the antenna elements are disposed on respective facets of a faceted surface.

12. The method of claim 10, wherein the antenna elements are disposed on respective portions of a surface.

13. The method of claim 10, wherein the antenna elements are disposed on a plurality of surfaces.

14. The method of claim 10, further comprising:
estimating a location of the RFID tag based on the first reply and second reply.

15. The method of claim 14, wherein estimating the location of the RFID tag comprises determining phase differences among the antenna elements in the first subset of antenna elements and among antenna elements in the second subset of antenna elements.

16. A sensor for interrogating a radio-frequency identification (RFID) tag, the sensor comprising:
a transceiver to generate at least one interrogation signal and receive at least one reply signal;
an antenna array, operably coupled to the transceiver and comprising antenna elements having boresights pointing in different directions, to transmit the at least one interrogation signal and detect the at least one reply signal;
at least one switch, operably coupled to the transceiver and the antenna array, to communicatively couple one or more of the antenna elements to the transceiver; and
a processor, operably coupled to the transceiver and the antenna elements, to process the at least one reply signal.

17. The sensor of claim 16, wherein the antenna elements are disposed on respective facets of a faceted surface.

18. The sensor of claim 16, wherein the antenna elements are disposed on respective portions of a surface.

19. The sensor of claim 16, wherein the antenna elements are disposed on a plurality of surfaces.

20. The sensor of claim 16, wherein the processor is further configured to estimate a location of the RFID tag based on the at least one reply signal.

21. A method for locating a radio-frequency identification (RFID) tag with an antenna array comprising antenna elements on respective facets of a faceted surface, the method comprising:
generating, with a transceiver operably coupled to the antenna array, a first interrogation signal;
transmitting the first interrogation signal from a first subset of antenna elements in the antenna array to the RFID tag, the first subset of antenna elements comprising a first plurality of antenna elements disposed at an elevation angle with respect to a centerline axis;
receiving, by at least the first subset of antenna elements, a first reply to the first interrogation signal from the RFID tag;
generating, with the transceiver, a second interrogation signal;
transmitting the second interrogation signal from a second subset of antenna elements in the antenna array to the RFID tag, the second subset of antenna elements comprising a second plurality of antenna elements disposed at the elevation angle with respect to the centerline axis; and
receiving, by at least the second subset of antenna elements, a second reply to the second interrogation signal from the RFID tag.

22. The method of claim 21, wherein each antenna element of the first plurality of antenna elements has a different azimuthal angle with respect to the centerline axis.

23. The method of claim 21, wherein each antenna element of the second plurality of antenna elements has a different azimuthal angle with respect to the centerline axis.

24. The method of claim 21, wherein the first plurality of antenna elements and the second plurality of antenna elements have at least one antenna element in common.

25. The method of claim 21, wherein:
the first plurality of antenna elements comprises a first antenna element, a second antenna element, and a third antenna element; and
the second plurality of antenna elements comprises the second antenna element, the third antenna element, and a fourth antenna element.

26. The method of claim 25, further comprising determining that the RFID tag did not move between receiving the first reply and receiving the second reply based on a phase difference between the second antenna element and the third antenna element of the first reply and a phase difference between the second antenna element and the third antenna element of the second reply remaining substantially unchanged.

27. The method of claim 25, wherein:
the first antenna element has a first azimuthal angle with respect to the centerline axis;
the second antenna element has a second azimuthal angle with respect to the centerline axis;
the third antenna element has a third azimuthal angle with respect to the centerline axis; and
the fourth antenna element has a fourth azimuthal angle with respect to the centerline axis.

28. The method of claim 21, wherein:
the antenna array further comprises a baseline antenna element disposed with a boresight parallel to the centerline axis;
the first subset of antenna elements comprises the baseline antenna element; and
the second subset of antenna elements comprises the baseline antenna element.

29. The method of claim 21, further comprising, after receiving the first reply to the first interrogation signal and before generating the second interrogation signal:
switching between the first plurality of antenna elements and the second plurality of antenna elements using at least one switch communicatively coupled to the first plurality of antenna elements, the second plurality of antenna elements, and the transceiver.

30. The method of claim 21, further comprising:
estimating a location of the RFID tag based on the first reply and second reply.

31. The method of claim 30, wherein estimating the location of the RFID tag comprises determining phase differences among the antenna elements in the first subset of antenna elements and among antenna elements in the second subset of antenna elements.
